(19) United States
(12) Patent Application Publication
(10) Pub. No.: US 2025/0349282 A1
(43) Pub. Date: Nov. 13, 2025

(54) PERSONALIZED AND DYNAMIC TEXT TO SPEECH VOICE CLONING USING INCOMPLETELY TRAINED TEXT TO SPEECH MODELS

(71) Applicant: MICROSOFT TECHNOLOGY LICENSING, LLC, Redmond, WA (US)

(72) Inventors: Bohan LI, Beijing (CN); Lei HE, Beijing (CN); Yan DENG, Beijing (CN); Bing LIU, Beijing (CN); Yanqing LIU, Beijing (CN); Sheng ZHAO, Beijing (CN)

(21) Appl. No.: 18/854,360

(22) PCT Filed: Apr. 13, 2022
(86) PCT No.: PCT/CN2022/086591

§ 371 Date: Oct. 4, 2024

(51) Int. Cl. G10L 13/033; G10L 13/047; G10L 13/08; G10L 15/02

(52) U.S. Cl. CPC G10L 13/033; G10L 13/047; G10L 13/086; G10L 15/02

(57) ABSTRACT

Systems and methods are provided for machine learning models configured as zero-shot personalized text-to-speech models which comprise a feature extractor, a speaker encoder, and a text-to-speech module. The feature extractor is configured to extract acoustic features and prosodic features from new target reference speech associated with the new target speaker. The speaker encoder is configured to generate a speaker embedding corresponding to the new target speaker based on the acoustic features extracted from the new target reference speech. The text-to-speech module is configured to generate the personalized voice corresponding for the new target speaker based on the speaker embedding and the prosodic features extracted from the new target reference speech without applying the text-to-speech module on new labeled training data associated with the new target speaker.

### BACKGROUND

Automatic speech recognition systems and other speech processing systems are used to process and decode audio data to detect speech utterances (e.g., words, phrases, and/or sentences). The processed audio data is then used in various downstream tasks such as search-based queries, speech to text transcription, language translation, etc. In contrast, text-to-speech (TTS) systems are used to detect text-based utterances and subsequently generate simulated spoken language utterances that correspond to the detected text-based utterances.

In most TTS systems, raw text is tokenized into words and/or phonetic units. Each word or phonetic unit is then associated with a particular phonetic transcription and prosodic unit, which forms a linguistic representation of the text. The phonetic transcription contains information about how to pronounce to the phonetic unit, while the prosodic unit contains information about larger units of speech, including intonation, stress, rhythm, timbre, speaking rate, etc. Once the linguistic representation is generated, a synthesizer or vocoder is able to transform the linguistic representation into synthesized speech which is audible and recognizable to the human ear.

Typically, conventional TTS systems require large amounts of labeled training data, first for training the TTS system as a speaker-independent and/or multi-lingual TTS system. However, large amounts of labeled date are also required in particular for personalizing a TTS system for a new speaker and/or new language for which it had not been previously trained. In view of the foregoing, there is an ongoing need for improved systems and methods for building and using low-latency, high-quality personalized TTS systems to generate synthesized speech from text-based input.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Disclosed embodiments include systems, methods, and devices for performing TTS processing and for generating and utilizing machine learning modules that are configured as zero-shot personalized for facilitating the generation of a personalized voice that will be used to generate synthesized speech from text-based input.

Some disclosed embodiments include machine learning models configured to generate a personalize voice for a new target speaker when the machine learning models have not yet been applied to any target reference speech associated with the new target speaker. These machine learning models include a zero-shot personalized text-to-speech model that comprise a feature extractor, a speaker encoder, and a text-to-speech module.

The feature extractor is configured to extract acoustic features and prosodic features from new target reference speech associated with the new target speaker.

The speaker encoder is configured to generate a speaker embedding corresponding to the new target speaker based on the acoustic features extracted from the new target reference speech.

The text-to-speech module is configured to generate the personalized voice corresponding for the new target speaker based on the speaker embedding and the prosodic features extracted from the new target reference speech without applying the text-to-speech module on new labeled training data associated with the new target speaker.

In such embodiments, the feature extractor, the speaker encoder, and the text-to-speech module are configured in a serial architecture within the machine learning model such that the acoustic features extracted by the feature extractor are provided as input to the speaker encoder and such that (i) the prosodic features extracted by the feature extractor and (ii) the speaker embedding generated by the speaker encoder are provided to the text-to-speech module. This configures the machine learning model as a zero-shot personalized text-to-speech model which is configured to generate the personalized voice for the new target speaker as model output in response to applying the machine learning model to new reference speech, such as the new target reference speech, as model input.

Disclosed systems are also configured for generating a personalized voice for a new target speaker using a zero-shot text-to-speech model described above. These systems access the described model and receive new target reference speech associated with the new target speaker and extract the acoustic features and the prosodic features from the new target reference speech. Subsequently, the systems use speaker encoder of the zero-shot personalized text-to-speech model to generate a speaker embedding corresponding to the new target speaker based on the acoustic features. Finally, the systems are able to generate the personalized voice for the new target speaker based on the speaker embedding and the prosodic features.

Disclosed systems are also configured for facilitating the creation of the aforementioned zero-shot personal text-to-speech models. Such systems, for example, comprise a first set of computer-executable instructions that are executable by one processors of a remote computing system for causing the remote computing system to perform a plurality of acts associated with a method for creating the zero-shot personal text-to-speech model and a second set of computer-executable instructions that are executable by one processors of a remote computing system for causing the remote computing system to send the first set of computer-executable instructions to the remote computing system.

The first instructions are executable for causing the remote system to access a feature extractor, a speaker encoder, and a text-to-speech module. The first instructions are also executable for causing the remote system to compile the feature extractor, the speaker encoder, and the text-to-speech module in a serial architecture, as the zero-shot personal text-to-speech model, such that the acoustic features extracted by the feature extractor are provided as input to the speaker encoder and such that (i) the prosodic features extracted by the feature extractor and (ii) the speaker embedding generated by the speaker encoder are provided as input to the text-to-speech module.

Additionally, some disclosed systems are configured such that the first set of computer-executable instructions further include instructions for causing the remote system to apply the text-to-speech module to a multi-speaker multi-lingual training corpus to train the text-to-speech module using not only TTS loss, such as Mel-spectrum, pitch, and/or duration loss, but also a speaker cycle consistency training loss, prior to generating the zero-shot personal text-to-speech model.

Some disclosed embodiments are also directed to systems and methods for generating and using a cross-lingual zero-shot personal text-to-speech model. In such embodiments, for example, the text-to-speech module is further configured to generate the personalized voice corresponding for the new target speaker based on the speaker embedding, the prosodic features, and a language embedding, and such that the machine learning model is configured as a cross-lingual zero-shot personalized text-to-speech model capable of generating speech in a second language that is different than a first language corresponding to the new target reference speech by using the personalized voice associated with the new target speaker.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments.

FIG. 2 illustrates an example embodiment of a process flow diagram for generating synthesized speech.

FIG. 3 illustrates an example embodiment of a feature extractor included in a zero-shot personalized text-to-speech model, for example the zero-shot personalized text-to-speech model of FIG. 2.

FIG. 4 illustrates an example embodiment of a speaker encoder included in a zero-shot personalized text-to-speech model, for example the zero-shot personalized text-to-speech model of FIG. 2.

FIG. 5 illustrates an example embodiment of a pre-trained text-to-speech module included in a zero-shot personalized text-to-speech model, for example the zero-shot personalized text-to-speech model of FIG. 2.

FIG. 6 illustrates an example embodiment of a process flow diagram for training a source text-to-speech model to be configured as a zero-shot personalized text-to-speech model.

FIG. 7 illustrates one embodiment of a flow diagram of a zero-shot personalized text-to-speech model.

FIG. 8 illustrates another embodiment of a flow diagram having a plurality of acts for generating a personalized voice using a zero-shot personalized text-to-speech model, for example the zero-shot personalized text-to-speech model shown in FIG. 7.

FIG. 9 illustrates one embodiment of a flow diagram having a plurality of acts associated with facilitating a creation of a zero-shot personalized text-to-speech model.

### DETAILED DESCRIPTION

Disclosed embodiments are directed towards improved systems, methods, and frameworks for facilitating the creation and use of machine learning models to generate a personalized voice for target speakers.

The disclosed embodiments provide many technical advantages over existing systems, including the generation and utilization of a high-quality TTS system architecture, which is sometimes referred to herein as a zero-shot personalized text-to-speech model, and which is capable of generating a personalized voice for a new target speaker without applying the model to new labeled training data associated with the new target speaker, as compared to conventional systems that do require additional training with new labeled training data, and without sacrificing quality that is achieved by such conventional systems.

Conventional zero-shot processing systems require additional training because they rely on techniques that utilize a speaker verification system to generate speaker embeddings that are fed into their Text-to-speech (TTS) systems without capturing the prosodic features of a target speaker, such as the fundamental frequency, energy and duration of the target speaker, and even though the prosodic features play an important role in voice cloning.

By implementing the disclosed embodiments, TTS systems are able to generate synthesized speech that is more natural and expressive, thereby increasing the synthesized speech's similarity to natural spoken language. Such TTS systems are able to synthesize a personalized voice (i.e., personal voice; cloned voice) for a target speaker using only a few audio clips without text transcripts from that speaker. After undergoing a training process, the TTS system can clone specific characteristics of the target speaker to incorporate in the personalized voice. The zero-shot methods disclosed herein enable cloning speaker voices by using only a few seconds of audio without corresponding text transcription from a new or unseen speaker as reference. And, as described, the disclosed systems are able to quickly clone the target speaker's characteristics by the speaker information that is extracted from the few seconds of reference audio.

The zero-shot method for speaker voice cloning beneficially utilizes a well-trained multi-speaker TTS source model. To clone an unseen voice, the systems only use the input of speaker information into the source model to directly synthesize speech for the new target speaker, without an additional training process. By using a zero-shot method for voice cloning, training computation costs are significantly reduced both in training time and because new sets of training data for the new target speaker do not need to be generated.

It will be appreciated that this is another benefit of the disclosed embodiments over conventional zero-shot TTS systems that focus on monolingual TTS scenarios, which means their synthesized speech is generated is in the same language as the reference speech. Unlike these conventional systems, the disclosed embodiments beneficially provide a framework for cross-lingual TTS voice cloning, which means synthesized speech can be generated in languages that are different from those corresponding to the reference audio.

The foregoing benefits are especially pronounced in real-time applications for voice cloning and synthesizing speech. Some examples of real-time applications include Skype Translator and other speech translators in IoT Devices.

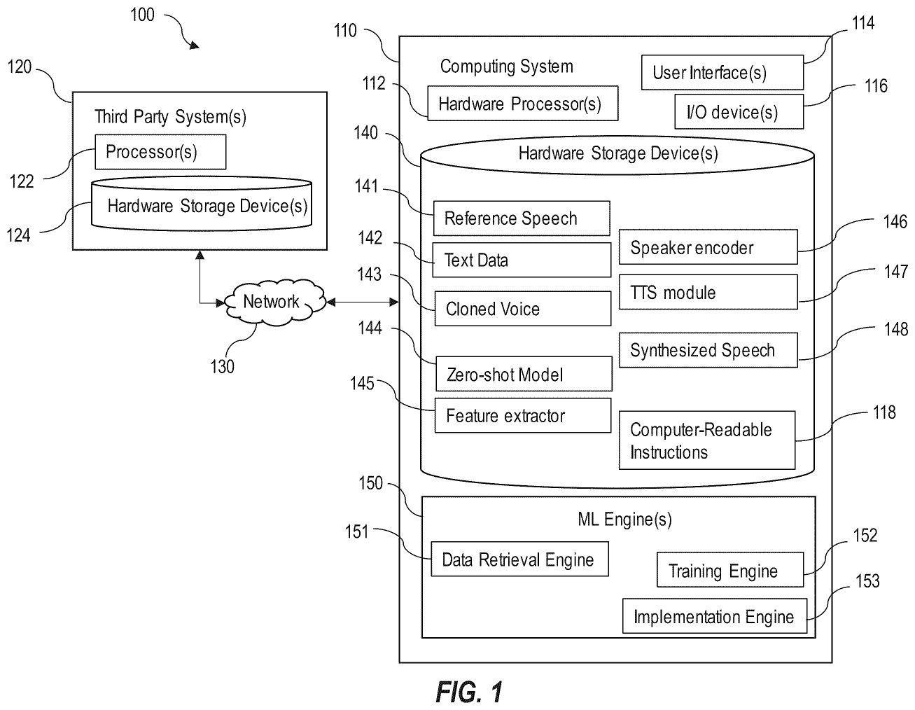

Attention will now be directed to FIG. 1, which illustrates components of a computing system 110 which may include and/or be used to implement aspects of the disclosed invention.

As shown, the computing system includes a plurality of machine learning (ML) engines, models, neural networks, and data types associated with inputs and outputs of the machine learning engines and models.

Attention will be first directed to FIG. 1, which illustrates the computing system 110 as part of a computing environment 100 that also includes third-party system(s) 120 in communication (via a network 130) with the computing system 110. The computing system 110 is configured to generate a personalized voice for a new target speaker and also generate synthesized speech using the personalized voice. The computing system 110 and/or third-party system(s) 120 (e.g., remote system(s)) is also configured for facilitating a creation of a zero-shot personalized text-to-speech model.

The computing system 110, for example, includes one or more processor(s) (such as one or more hardware processor(s) 112) and a storage (i.e., hardware storage device(s) 140) storing computer-readable instructions 118 wherein one or more of the hardware storage device(s) 140 is able to house any number of data types and any number of computer-readable instructions 118 by which the computing system 110 is configured to implement one or more aspects of the disclosed embodiments when the computer-readable instructions 118 are executed by the one or more processor(s) 112. The computing system 110 is also shown including user interface(s) 114 and input/output (I/O) device(s) 116.

As shown in FIG. 1, hardware storage device(s) 140 is shown as a single storage unit. However, it will be appreciated that the hardware storage device(s) 140 is, a distributed storage that is distributed to several separate and sometimes remote systems and/or third-party system(s) 120. The computing system 110 can also comprise a distributed system with one or more of the components of computing system 110 being maintained/run by different discrete systems that are remote from each other and that each perform different tasks. In some instances, a plurality of distributed systems performs similar and/or shared tasks for implementing the disclosed functionality, such as in a distributed cloud environment.

The storage (e.g., hardware storage device(s) 140) includes computer-readable instructions 118 for instantiating or executing one or more of the models and/or engines shown in computing system 110 (e.g., the zero-shot model 144 (e.g., a zero-shot personalized text-to-speech model, as described herein), the feature extractor 145, the speaker encoder 146, the TTS module 147, the data retrieval engine 151, the training engine 152, and/or the implementation engine 153).

The models are configured as machine learning models or machine learned models, such as deep learning models and/or algorithms and/or neural networks. In some instances, the one or more models are configured as engines or processing systems (e.g., computing systems integrated within computing system 110), wherein each engine comprises one or more processors (e.g., hardware processor(s) 112) and computer-readable instructions 118 corresponding to the computing system 110. In some configurations, a model is a set of numerical weights embedded in a data structure, and an engine is a separate piece of code that, when executed, is configured to load the model, and compute the output of the model in context of the input audio.

The hardware storage device(s) 140 are configured to store and/or cache in a memory store the different data types including the reference speech 141, the input text, the cloned voice 143 (e.g., personalized voice), and/or the synthesized speech 148, described herein.

Herein, “training data” refers to labeled data and/or ground truth data configured to be used to pre-train the TTS model used as the source model that is configurable as the zero-shot model 144. In contrast, the reference speech 141 comprises only natural language audio, for example, reference speech 141 recorded from a particular speaker.

Utilizing the personalized training methods described herein, the zero-shot model 144 uses only a few seconds of ground truth data based on the reference speech from a new target speaker to configure the model to generate/clone a personalized voice for the new target speaker. This is an improvement over conventional models in that the systems do not need to obtain labeled training data to fine-tune the zero-shot model 144 when a new personalized voice is generated for a new target speaker.

With regard to the use of the term “zero-shot”, as used in reference to the disclosed zero-shot models, it will be appreciated that the term generally means that the corresponding zero-shot model is capable of and configured to generate a personalized voice for a new target speaker in response to applying the zero-shot model to target reference speech (audio) from a new target speaker, and even though that model has not been previously applied to any target reference speech or audio associated with the new target speaker.

In some instances, natural language audio, such as can be used for the new target reference speech, is extracted from previously recorded files such as video recordings having audio or audio-only recordings. Some examples of recordings include videos, podcasts, voicemails, voice memos, songs, etc. Natural language audio is also extracted from actively streaming content which is live continuous speech such as a news broadcast, phone call, virtual or in-person meeting, etc. In some instances, a previously recorded audio file is streamed. Natural audio data comprises spoken language utterances without a corresponding clean speech reference signal. Natural audio data is recorded from a plurality of sources, including applications, meetings comprising one or more speakers, ambient environments including background noise and human speakers, etc. It should be appreciated that the natural language audio comprises one or more spoken languages of the world's spoken languages. Thus, the zero-shot model 144 is trainable in one or more languages.

The training data comprises spoken language utterances (e.g., natural language and/or synthesized speech) and corresponding textual transcriptions (e.g., text data). The training data comprises text data and natural language audio and simulated audio that comprises speech utterances corresponding to words, phrases, and sentences included in the text data. In other words, the speech utterances are the ground truth output for the text data input. The natural language audio is obtained from a plurality of locations and applications.

Simulated audio data comprises a mixture of simulated clean speech (e.g., clean reference audio data) and one or more of: room impulse responses, isotropic noise, or ambient or transient noise for any particular actual or simulated environment or one that is extracted using text-to-speech technologies. Thus, parallel clean audio data and noisy audio data is generated using the clean reference audio data on the one hand, and a mixture of the clean reference audio data and background noise data. Simulated noisy speech data is also generated by distorting the clean reference audio data.

The text data 142 comprises sequences of characters, symbols, and/or number extracted from a variety of sources. For example, the text data 142 comprises text message data, contents from emails, newspaper articles, webpages, books, mobile application pages, etc. In some instances, the characters of the text data 142 are recognized using optical text recognition of a physical or digital sample of text data 142. Additionally, or alternatively, the characters of the text data 142 are recognized by processing metadata of a digital sample of text data 142.

Text data 142 is also used to create dataset of input text that is configured to be processed by the zero-shot model 144 in order to generate synthesized speech 148. In such examples, the input text comprises a same, similar, or different sub-set of text data 142 than the training datasets used to train the source model.

The synthesized speech 148 comprises synthesized audio data comprising speech utterances corresponding to words, phrases, and sentences recognized in the text data 142. The synthesized speech 148 using a cloned voice 143 and input text comprising text data 142. The synthesized speech 148 comprises speech utterances that can be generated in different target speaker voices (i.e., cloned voices), different languages, different speaking styles, etc. The synthesized speech 148 comprises speech utterances that are characterized by the reference speech features (e.g., acoustic features, linguistic features, and/or prosodic features) extracted by the feature extractor 145. The synthesized speech 148 is beneficially generated to mimic natural language audio (e.g., the natural speaking voice of the target speaker).

An additional storage unit for storing machine learning (ML) Engine(s) 150 is presently shown in FIG. 1 as storing a plurality of machine learning models and/or engines. For example, computing system 110 comprises one or more of the following: a data retrieval engine 151, a training engine 152, and an implementation engine 153, which are individually and/or collectively configured to implement the different functionality described herein.

The computing system also is configured with a data retrieval engine 151, which is configured to locate and access data sources, databases, and/or storage devices comprising one or more data types from which the data retrieval engine 151 can extract sets or subsets of data to be used as training data (e.g., training data) and as input text data (e.g., text data 142). The data retrieval engine 151 receives data from the databases and/or hardware storage devices, wherein the data retrieval engine 151 is configured to reformat or otherwise augment the received data to be used in the text recognition and TTS applications.

Additionally, or alternatively, the data retrieval engine 151 is in communication with one or more remote systems (e.g., third-party system(s) 120) comprising third-party datasets and/or data sources. In some instances, these data sources comprise audio-visual services that record or stream text, images, and/or video. The data retrieval engine 151 is configured to retrieve text data 142 in real-time, such that the text data 142 is “streaming” and being processed in real-time (i.e., a user hears the synthesized speech 148 corresponding to the text data 142 at the same rate as the text data 142 is being retrieved and recognized).

The data retrieval engine 151 is a smart engine that is able to learn optimal dataset extraction processes to provide a sufficient amount of data in a timely manner as well as retrieve data that is most applicable to the desired applications for which the machine learning models/engines will be used. The audio data retrieved by the data retrieval engine 151 can be extracted/retrieved from mixed media (e.g., audio visual data), as well as from recorded and streaming audio data sources.

The data retrieval engine 151 locates, selects, and/or stores raw recorded source data (e.g., the extracted/retrieved audio data) wherein the data retrieval engine 151 is in communication with one or more other ML engine(s) and/or models included in computing system 110. In such instances, the other engines in communication with the data retrieval engine 151 are able to receive data that has been retrieved (i.e., extracted, pulled, etc.) from one or more data sources such that the received data is further augmented and/or applied to downstream processes. For example, the data retrieval engine 151 is in communication with the training engine 152 and/or implementation engine 153.

The training engine 152 is configured to train the parallel convolutional recurrent neural networks and/or the individual convolutional neural networks, recurrent neural networks, learnable scalars, or other models included in the parallel convolutional recurrent neural networks. The training engine 152 is configured to train the zero-shot model 144 and/or the individual model components (e.g., feature extractor 145, speaker encoder 146, and/or TTS module 147, etc.).

The computing system 110 includes an implementation engine 153 in communication with any one of the models and/or ML engine(s) 150 (or all of the models/engines) included in the computing system 110 such that the implementation engine 153 is configured to implement, initiate, or run one or more functions of the plurality of ML engine(s) 150. In one example, the implementation engine 153 is configured to operate the data retrieval engine 151 so that the data retrieval engine 151 retrieves data at the appropriate time to be able to obtain text data for the Zero-shot model 144 to process. The implementation engine 153 facilitates the process communication and timing of communication between one or more of the ML engine(s) 150 and is configured to implement and operate a machine learning model (or one or more of the ML engine(s) 150) which is configured as a Zero-shot model 144.

By implementing the disclosed embodiments in this manner, many technical advantages over existing systems are realized, including the ability to generate improved TTS systems that can quickly and efficiently generate a new cloned voice that can be used to generate synthesized speech without having to fine-tune the TTS system, as opposed to conventional TTS systems which require one or more additional training iterations using training data for a new target speaker in order to generate a cloned voice for the new target speaker.

Overall, disclosed systems improve the efficiency and quality of transmitting linguistical, acoustic, and prosodic meaning into the cloned voice 143 and, subsequently, the synthesized speech 148, especially in streaming mode. This also improves the overall user experience by reducing latency, increasing the quality of the speech (i.e., the synthesized speech is clear/understandable and sounds like natural speech).

The computing system is in communication with third-party system(s) 120 comprising one or more processor(s) 122, one or more of the computer-readable instructions 118, and one or more hardware storage device(s) 124. It is anticipated that, in some instances, the third-party system(s) 120 further comprise databases housing data that could be used as training data, for example, text data not included in local storage. Additionally, or alternatively, the third-party system(s) 120 include machine learning systems external to the computing system 110. The third-party system(s) 120 are software programs or applications.

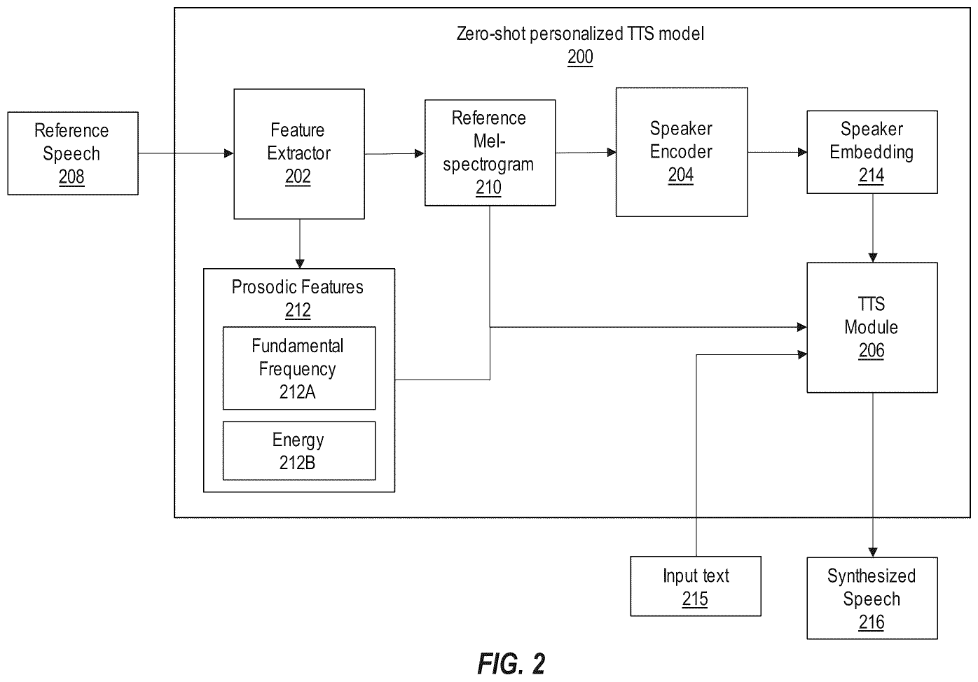

Attention will now be directed to FIG. 2, which illustrates an example embodiment of a process flow diagram for generating synthesized speech using a zero-shot personalized text-to-speech model 200 (e.g., shown as zero-shot model 144 in FIG. 1).

As shown, the model 200 consists of three primary modules, a feature extraction module (e.g., feature extractor 202), a speaker encoder module (e.g., speaker encoder 204) and a TTS module (e.g., TTS module 206). The feature extraction module removes noises in the reference audio (e.g., reference speech 208) of target speaker, then extracts acoustic and prosodic features from the denoised audio. The speaker encoder module then takes the acoustic features as input, and output speaker embedding, which represents speaker identity of target speaker. Acoustic features include audio features such as vowel sounds, consonant sounds, length, and emphasis of individual phonemes, as well as speaking rate, speaking volume, and whether there are pauses in between words. Linguistic features are characteristics used to classify audio data as phonemes and words. Linguistic features also include grammar, syntax, and other features associated with the sequence and meaning of words. These words form speech utterances that are recognized by the TTS system (e.g., Zero-shot model 144). The TTS module then synthesizes speech in a zero-shot manner by consuming the speaker embedding along with prosodic features extracted from reference audio.

As mentioned previously, conventional zero-shot processing techniques use a speaker verification system to generate speaker embedding and feed the embedding into Text-to-speech (TTS) system. These conventional techniques only capture the identity of target speaker, not the prosodic features, such as fundamental frequency, energy and duration of target speaker, which play an important role in the voice cloning techniques that are described herein.

As illustrated, the currently disclosed zero-shot personalized TTS model 200 is applied to reference speech 208 which is received as input to the feature extractor 202. The feature extractor 202 extracts acoustic features (e.g., reference Mel-spectrogram 210) and prosodic features 212 including the fundamental frequency 212A and the energy 212B. The reference Mel-spectrogram 210 is received by the speaker encoder 204 which generates a speaker embedding 214. The TTS module 206 is then applied to the prosodic features 212 and speaker embedding 214 in order to generate a personalized voice that captures the identity of the speaker, as well as the acoustic and prosodic characteristics of the natural speaking voice of the target speaker.

After the personalized voice is cloned/generated, the TTS module 206 can be applied to input text 215 in order to generate synthesized speech 216 that comprises synthesized language utterances corresponding to textual utterances for the input text 215 and which is generated with the personalized voice. Some applications for utilizing the voice cloning and synthesizing speech of the TTS module 206 include hands-free email and text TTS readers, interactive and multiplayer game chat interfaces, and so forth. Other practical downstream uses for the configured TTS module 206 include, for example, real-time multilingual applications, such as the Skype Translator application and other speech translators incorporated into IoT Devices.

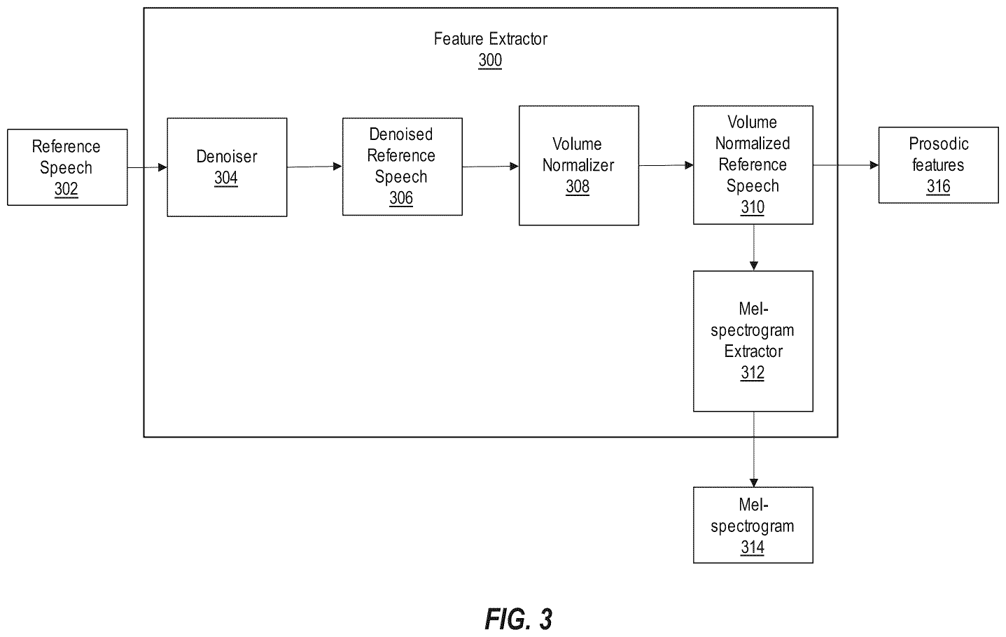

Attention will now be directed to FIG. 3, which illustrates an example embodiment of a feature extractor included in a zero-shot personalized text-to-speech model, for example the zero-shot personalized text-to-speech model of FIG. 2. The first module of the zero-shot personalized text-to-speech model is the feature extractor 300. This module denoises the reference speech spoken by target unseen speaker, then extracts acoustic features, such as Mel-spectrogram and prosodic features, including fundamental frequency and energy, these features are feed into speaker encoder and TTS module.

For example, the denoiser 304 of the feature extractor 300, which is applied to reference speech 302, utilizes a spectral subtraction method for denoising which restores the power of the spectrum of a signal observed in additive noise through subtraction of an estimate of the average noise spectrum from the noisy signal. The denoiser 304 generates a denoised reference speech 306 (e.g., clean reference audio) which is then received by a volume normalizer 308. The volume normalizer 308 is configured to normalize the volume of the denoised reference speech 306 and generate a volume normalized reference speech 310. A Mel-spectrogram extractor 312 is then applied to the volume normalized reference speech 310 in order to extract a Mel-spectrogram 314. In some instances, the Mel-spectrogram extractor 312 is configured to apply a short-term Fourier transform (i.e., STFT) to the volume normalized reference speech 310 in order to convert it to the Mel scale.

Using the configuration described above, a Mel-spectrogram 314 is generated for a new target speaker based on the reference speech 302 obtained from the new target speaker. The Mel-spectrogram 314 is utilized throughout the zero-shot personalized text-to-speech model to ensure that acoustic features of the new target speaker remain embedded in the personalized voice and subsequently synthesized speech generated using the personalized voice.

In the foregoing configuration, the feature extractor 300 is also configured to extract prosodic features 316 from the volume normalized reference speech, including fundamental frequency associated with the reference speech 302 and an energy associated with reference speech 302.

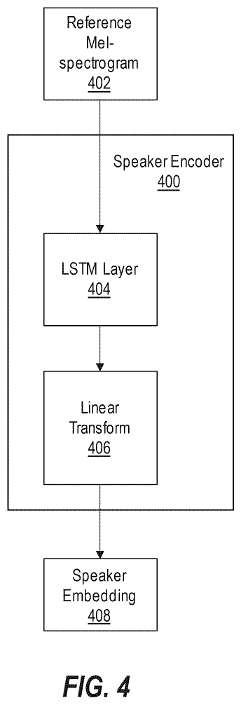

Attention will now be directed to FIG. 4, which illustrates an example embodiment of a speaker encoder included in a zero-shot personalized text-to-speech model, for example the zero-shot personalized text-to-speech model of FIG. 2. The speaker encoder 400 takes a reference Mel-spectrogram (e.g., Mel-spectrogram 314 from FIG. 3) as input and generates a 256-dimension speaker embedding for each target speaker (e.g., speaker embedding 408) based on each Mel-spectrogram received. As shown in FIG. 4, the speaker encoder 400 comprises one or more LSTM layers (e.g., LSTM layer 404) and linear transform layer 406.

The input is a reference Mel-spectrogram 402 extracted from reference audio, wherein one or more LSTM layers (e.g., LSTM layer 404) are applied to the reference Mel-spectrogram 402 in order to generate speaker embedding. The linear transform layer 406 and a RELU activation function convert the information into a 256-dimension space. In some instances, this module is built by knowledge distillation from an internal pretrained speaker verification model.

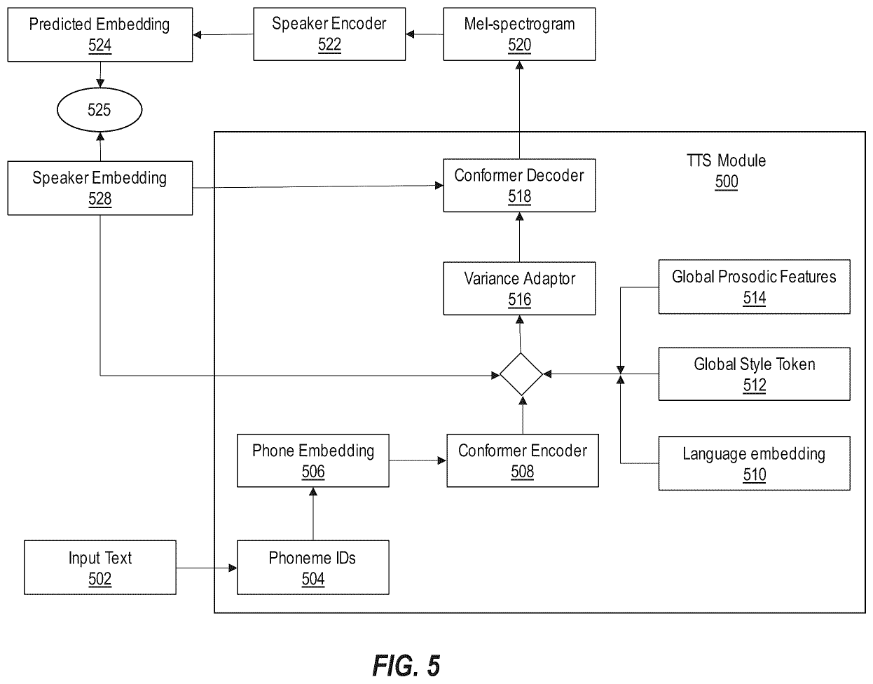

Attention will now be directed to FIG. 5, which illustrates an example embodiment of a text-to-speech module included in a zero-shot personalized text-to-speech model, for example the zero-shot personalized text-to-speech model of FIG. 2. After the speaker encoder, the TTS module takes the speaker embedding, prosodic features, and text as input and generates synthesized speech of the target speaker as output. As illustrated in FIG. 5, the TTS module comprises components based on a conformer TTS model, wherein the TTS module 500 takes input text 502 and converts it to phoneme identifiers (e.g., Phoneme IDs 504). These are then converted to a phone embedding 506.

The conformer encoder 508 takes the phonemes (e.g., phone embeddings 506) as input and outputs a representation of the input phoneme which is combined with other embeddings (e.g., language embedding 510, global style token 512, global prosodic features 514, and speaker embedding 528) to generate a combination of embeddings that are provided to the variance adaptor 516. Each of the different embeddings will now be described in more detail.

The speaker embeddings 528, for example, comprise the embeddings that are generated by the speaker encoder 522 in response to speaker input samples.

The global prosodic features 514 (e.g., at utterance level) include fundamental frequency and energy which are extracted from reference speech. Such global prosodic features 514 are adopted to enhance the similarity between the human recording (e.g., target speaker reference speech) and synthesized speech. In particular, the addition of fundamental frequency and energy of reference audio can help the TTS module to capture speaker prosody in a disentangled fashion.

The global style tokens 512 are generated by a global style token module which consists of a reference encoder and a style attention layer. The global style token module is configured to help capture residual prosodic features, including the speaking rate of the target speaker, in addition to other prosodic features extracted using the feature extractor.

The referenced language embeddings 510 includes language information for each language identified in the input text 502 and/or reference speech.

The combination of embeddings, as described above, is finally received by the variance adaptor 516. The variance adaptor 516 is used to predict phoneme duration, which means it predicts the total time taken by each phoneme. It also predicts the phone-level fundamental frequency, which is the relative highness or lowness of a tone as perceived by human.

After the phone-level duration and fundamental frequency prediction, the encoder output expands according to phoneme duration, which is then input into the conformer decoder 518. The conformer decoder 518 is configured to generate acoustic features, such as predicted Mel-spectrogram (e.g., Mel-spectrogram 520) for the target speaker voice.

Finally, a vocoder (such as a well-trained Universal MeIGAN vocoder, for example), can be used to convert the predicted Mel-spectrogram to waveforms.

In some embodiments, the conformer decoder is replaced by a flow-based decoder. During the source model training stage, the flow-based decoder receives as input a ground truth Mel-spectrogram and outputs a prior distribution, which may be output in the form of a multivariate gaussian distribution. By employing a monotonic alignment search between the prior distribution and the encoder output, the module can learn alignments between the text and Mel-spectrogram, without ground truth duration as guidance. During the inference stage, the encoder output expands according to the predicted duration and inputs the expanded encoder output into a decoder in a reverse direction.

Using the flow-based architecture described above, the model is able to learns proper

target speaker alignment without a requirement of ground truth duration from an external tool.

This can help TTS module synthesize more natural sounding speech for the target speaker.

Additionally, during training, the predicted embedding 524 is aligned with speaker embedding 528 using a cycle loss training method (e.g., cycle loss 525), such that the predicted speaker embedding is more accurately aligned with the target speaker's natural speaking voice.

For cross-lingual speech synthesis, disclosed embodiments use the language embedding 510 to control language information. In some instances, the language embedding is accessed from a look up table. For example, when given the target language identity as input, this table returns a dense representation of it (e.g., the language embedding 510). In addition, with the speaker embedding conditioned on the decoder layer norm, the target speaker identity and timbre can retain more accurately and at a higher quality for cross-lingual speech synthesis.

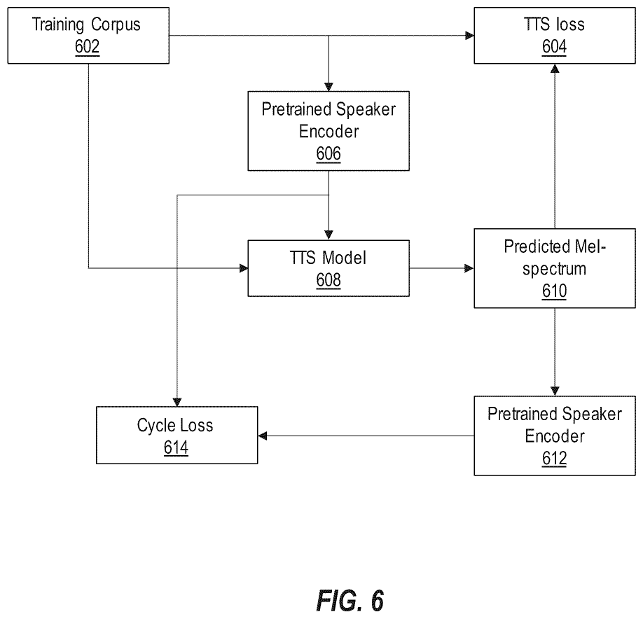

Attention will now be directed to FIG. 6, which illustrates an example embodiment of a process flow diagram for training a source text-to-speech model to be configured as a zero-shot personalized text-to-speech model. For the multi-speaker multi-lingual source TTS model training, systems are configured to train the source model on thousands of speakers covering a plurality of locales and more than six thousand hours of human recording included in the training corpus 602. The training corpus 602 enhances the model's robustness and capacity. A speaker cycle consistency training loss (e.g., cycle loss 614) is added to minimize cosine similarity between speaker embedding generated from ground truth and synthesized audio, which encourages the TTS model 608 to synthesize higher speaker similarity speech. Given a larger training corpus, the TTS model can be adapted to previously unseen speakers. In some instances, the parameters in speaker encoder 606 are fixed during source model training.

As illustrated in FIG. 6 the training corpus 602 is transmitted to the TTS model 608, the speaker encoder 606, and the TSS loss 604. The TTS model 608 is configured to generate a predicted Mel-spectrum 610. This predicted Mel-spectrum is sent to the pretrained speaker encoder 612, wherein output from speaker encoder 606 and output from pretrained speaker encoder 612 are aligned using the cycle loss 614. Once the source model training is finished of the TTS model 608, it is used as the pre-trained TTS module in the zero-shot voice cloning framework. In some instances, speaker encoder 606 and speaker encoder 612 are the same speaker encoder model. Alternatively, speaker encoder 606 and speaker encoder 612 are distinct speaker encoder models.

When cloning an unseen voice (a target voice for a target speaker and one that has not yet been applied to the model), and in response to receiving reference audio from the target speaker, the TTS module takes the speaker embedding and prosodic features of the target/unseen voice as inputs, then quickly synthesizes natural speech of the target speaker corresponding to these input features.

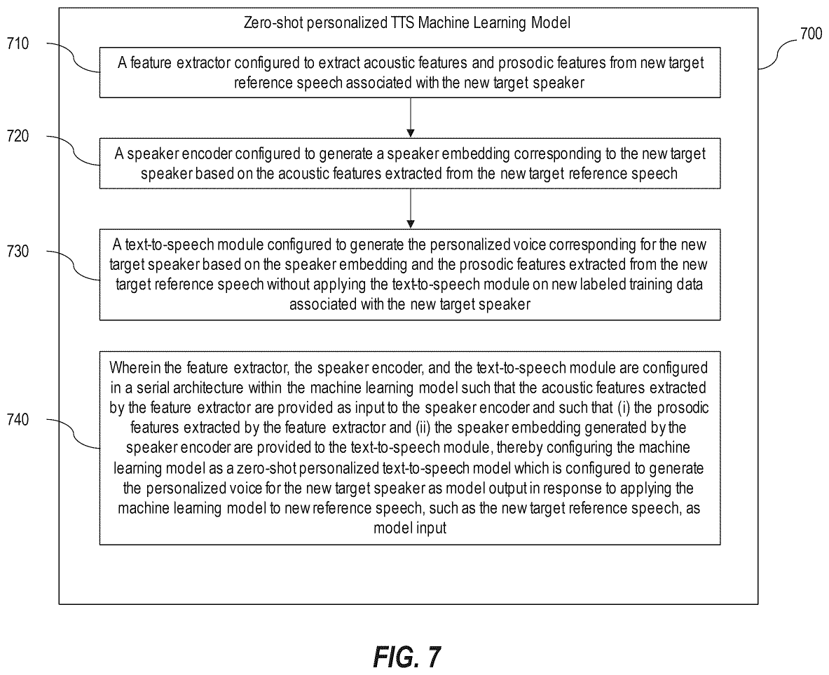

Attention will now be directed to FIG. 7 which illustrates a zero-shot personalized TTS machine learning model 700 that includes various modules (module 710, module 720, and module 730, which are arranged according to the serial architecture described in reference box 740).

The feature extractor 710 is configured to extract acoustic features and prosodic features from new target reference speech associated with the new target speaker. By extracting both acoustic features and prosodic features, the personalized voice that is generated using such extracted features will retain a higher quality and similarity to the target speaker's natural speaking voice.

The speaker encoder 720 is configured to generate a speaker embedding corresponding to the new target speaker based on the acoustic features extracted from the new target reference speech. The speaker embedding beneficially retains an accurate speaker identity as well as the acoustic features extracted by the feature extractor.

The text-to-speech module 730 is configured to generate the personalized voice corresponding for the new target speaker based on the speaker embedding and the prosodic features extracted from the new target reference speech without applying the text-to-speech module on new labeled training data associated with the new target speaker.

As previously mentioned, the foregoing feature extractor, speaker encoder and text-to-speech module are arranged/configured in a serial architecture (configuration 740), such that the acoustic features extracted by the feature extractor are provided as input to the speaker encoder and such that (i) the prosodic features extracted by the feature extractor and (ii) the speaker embedding generated by the speaker encoder are provided to the text-to-speech module. With this configuration, it is possible to generate the personalized voice for the new target speaker as model output in response to applying the machine learning model to model input comprising new/target reference speech.

Such a configuration is very beneficial for facilitating training of the model since the systems configured with such a model need just the simple input of a speaker, which is provided as input to the source model, for enabling the source model to synthesize speech using the cloned voice, without any additional training processes with speaker labeled data. Such a zero-shot method is very helpful to reduce training computation costs for large scale applications.

Overall, disclosed systems improve the efficiency and quality of transmitting linguistical, acoustic, and prosodic meaning into the cloned voice and, subsequently, the synthesized speech, especially in streaming applications.

Additional applications and modifications of the foregoing models include the inclusion of a denoiser configured to denoise the new target reference speech prior to providing it to the model for training the model to clone the target speaker voice.

Additionally, the models may also include one or more of (1) a conformer encoder configured to generate phoneme representations in response to receiving phonemes, (2) a variance adaptor configured to predict phoneme duration and phone-level fundamental frequency in response to receiving the speaker embedding generated by the speaker encoder, (3) a global style token module configured to capture residual prosodic features and generate a style token and that is configured to capture a speaking rate associated with new target speaker.

In some alternative embodiments, the zero-shot personalized text-to-speech model is also configurable as a multi-lingual model, wherein the text-to-speech module is specifically configured to generate the personalized voice corresponding for the new target speaker based on the speaker embedding, the prosodic features, and a language embedding. With such a configuration, the machine learning model is configured as a cross-lingual zero-shot personalized text-to-speech model capable of generating speech in a second language that is different than a first language corresponding to the new target reference speech by using the personalized voice associated with the new target speaker.

When the zero-shot personalized text-to-speech model is configured as a multi-lingual and/or cross-lingual TTS system, the new target reference speech comprises spoken language utterances in a first language and the new input text comprises text-based language utterances in a second language. Using such configurations, systems are able to identify a new target language based on the second language associated with the new input text, access a language embedding configured to control language information for the synthesized speech, and generate the synthesized speech in the second language using the language embedding. This allows the model to generate synthesized speech for a target speaker in a language that is not the target speaker's native language, without sacrificing inherent acoustic and prosodic features of the target speaker's natural speaking voice (as embodied in the cloned voice).

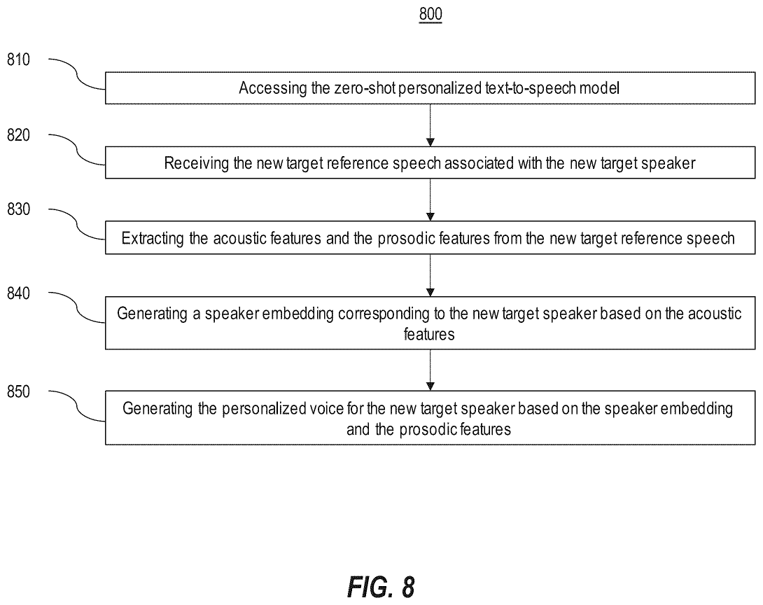

Attention will now be directed to FIG. 8 which illustrates a flow diagram 800 that includes various acts (act 810, act 820, act 830, act 840, and act 850) associated with exemplary methods that can be implemented by computing system 110 for generating a personalized voice for a new target speaker using the zero-shot personalized text-to-speech models and configurations described above.

The first illustrated act includes a computing system accessing a zero-shot personalized text-to-speech model (e.g., machine learning model 700) (act 810). Next, the system obtains new target reference speech associated with the new target speaker (act 820) and extract the acoustic features and the prosodic features from the new target reference speech (act 830). Subsequently, the system generates a speaker embedding corresponding to the new target speaker based on the acoustic features (act 840). Finally, the system generates the personalized voice for the new target speaker based on the speaker embedding and the prosodic features (act 850).

Such methods provide many technical advantages over the use of conventional TTS systems, including the ability to quickly and efficiently generate a new cloned voice that can be used to generate synthesized speech without having to fine-tune the TTS system. In particular, conventional TTS systems require one or more additional training iterations using training data for a new target speaker in order to generate a cloned voice for the new target speaker. Accordingly, disclosed methods and systems facilitate cloning a target voice with an overall reduction in the training costs required, as well as a reduction in the latency for performing the training.

Some embodiments are also directed to methods for generating synthesized speech using the personalized voice from the specially configured models. For example, some disclosed systems are configured to receive new input text at the text-to-speech module and to generate synthesized speech in the personalized voice based on the new input text. This synthesized speech retains a high similarity to the target speaker's natural voice.

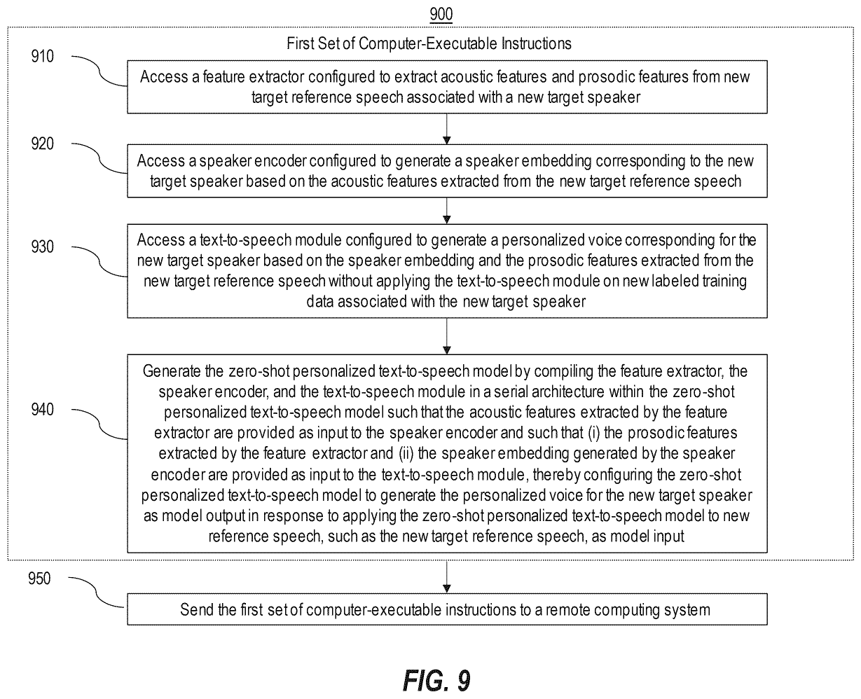

Attention will now be directed to FIG. 9 illustrates a flow diagram 900 that includes various acts (act 910, act 920, act 930, act 940, and act 950) associated with exemplary methods that can be implemented by computing system 110 for facilitating a creation of a zero-shot personalized text-to-speech model.

As shown, acts 910, 920, 930 and 940 illustrate acts that are specifically associated with a first set of computer-executable instructions that are executable (at a local or remote system) for generating/compiling the zero-shot personalized TTS models described herein. The remaining act (act 950) is associated with a second set of computer-executable instructions for causing the first set of computer-executable instructions to be transmitted to a remote system for causing the remote system to generate/compile the zero-shot personalized TTS model.

As shown, act 910 includes a computing system accessing a feature extractor configured to extract acoustic features and prosodic features from new target reference speech associated with a new target speaker.

Act 920 is for the computing system to access a speaker encoder configured to generate a speaker embedding corresponding to the new target speaker based on the acoustic features extracted from the new target reference speech.

Act 930 is for the system to access a text-to-speech module configured to generate a personalized voice corresponding for the new target speaker based on the speaker embedding and the prosodic features extracted from the new target reference speech without applying the text-to-speech module on new labeled training data associated with the new target speaker.

Finally, act 940 is for the computing system (e.g., a local or a remote system), to generate the zero-shot personalized text-to-speech model by compiling the feature extractor, the speaker encoder, and the text-to-speech module in a serial architecture within the zero-shot personalized text-to-speech model, such that the acoustic features extracted by the feature extractor are provided as input to the speaker encoder and such that (i) the prosodic features extracted by the feature extractor and (ii) the speaker embedding generated by the speaker encoder are provided as input to the text-to-speech module.

Once generated, the zero-shot personalized text-to-speech model is configured to generate the personalized voice for the new target speaker as model output in response to applying the zero-shot personalized text-to-speech model to model input that comprises new/target reference speech.

As will be appreciated, computer-executable instructions for implementing acts 910, 920, 930 and 940 (e.g., a first set of instructions) can be executed by a local system storing the first set of instructions and/or by a remote system that is sent the first set of instructions for execution to create the referenced zero-shot personalized TTS model. In particular, the disclosed methods include, in some instances, sending the first set of instructions to the remote computing system (act 950). In such embodiment, the first set of instructions may include instructions to execute the first set of instructions and for, thereby, causing the remote computing system to execute the first set of computer-executable instructions for generating the zero-shot personalized text-to-speech model.

Additionally, in some alternative embodiments, the first set of computer-executable instructions further include instructions for causing the remote system to apply the text-to-speech module to a multi-speaker multi-lingual training corpus to train the text-to-speech module using a speaker cycle consistency training loss.

In view of the foregoing, it will be appreciated that the disclosed embodiments provide many technical benefits over conventional systems and methods for generating a personalized voice for a new target speaker using a zero-shot personalized text-to-speech model. By implementing the disclosed embodiments in this manner, many technical advantages over existing systems are realized, including the ability to generate improved TTS systems that can quickly and efficiently generate a new cloned voice that can be used to generate synthesized speech without having to fine-tune the TTS system, as opposed to conventional TTS systems which require one or more additional training iterations using training data for a new target speaker in order to generate a cloned voice for the new target speaker.

### EXAMPLE COMPUTING SYSTEMS

Embodiments of the present invention may comprise or utilize a special purpose or general-purpose computer (e.g., computing system 110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media (e.g., hardware storage device(s) 140 of FIG. 1) that store computer-executable instructions (e.g., computer-readable instructions 118 of FIG. 1) are physical hardware storage media/devices that exclude transmission media. Computer-readable media that carry computer-executable instructions or computer-readable instructions (e.g., computer-readable instructions 118) in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 130 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system configured to instantiate a machine learning model that is capable of generating a personalized voice for a new target speaker in response to applying the machine learning model to target reference speech from a new target speaker, the machine learning model having not been previously applied to any labeled training data associated with the new target speaker, the computing system:
one or more processors; and
one or more storage devices storing computer-executable instructions which are executable by the one or more processors for instantiating a machine learning model that is configured to:
extract acoustic features and prosodic features from new target reference speech;
generate a speaker embedding corresponding to the new target speaker based on the extracted acoustic features; and
generate the personalized voice corresponding for the new target speaker based on text-to-speech processing with both the speaker embedding and the prosodic features extracted from the new target reference speech without first applying the machine learning model to any labeled training data associated with the new target speaker; and
use the extracted acoustic features to generate the speaker embedding and to utilize both (i) the extracted prosodic features and (ii) the speaker embedding to generate the personalized voice for the new target speaker as output in response to applying the machine learning model to input comprising the new target reference speech.

2. The computing system of claim 1, wherein the acoustic features include a Mel-spectrogram.

3. The computing system of claim 1, wherein the prosodic features include one or more of: a fundamental frequency or an energy.

4. The computing system of claim 1, wherein the machine learning model is further configured to:
generate phoneme representations in response to receiving phonemes;
predict phoneme duration and phone-level fundamental frequency in response to receiving the speaker embedding; and
decode the speaker embedding along with encoder output and other input features.

5. The computing system of claim 1, wherein the machine learning model is further configured to capture residual prosodic features and generate a style token.

6. The computing system of claim 5, wherein the machine learning model is further configured to capture a speaking rate associated with new target speaker.

7. The computing system of claim 1, wherein the machine learning model is further configured to generate the personalized voice corresponding for the new target speaker based on the speaker embedding, the prosodic features, and a language embedding, such that the machine learning model is configured as a cross-lingual personalized text-to-speech model capable of generating speech in a second language that is different than a first language corresponding to the new target reference speech by using the personalized voice associated with the new target speaker.

8. The computing system of claim 1, wherein the machine learning model is further configured to denoise the new target reference speech.

9. A method for generating a personalized voice for a new target speaker using a zero-shot personalized text-to-speech model, the method comprising:
accessing a personalized text-to-speech model that is configured to generate a personalized voice corresponding for a new target speaker based on speaker embeddings and prosodic features extracted from new target reference speech of the new target speaker, and without having to first fine-tune the text-to-speech model based on new labeled training data associated with the new target speaker;
receiving the new target reference speech associated with the new target speaker;
extracting the acoustic features and the prosodic features from the new target reference speech;
generating a speaker embedding corresponding to the new target speaker based on the acoustic features; and
generating the personalized voice for the new target speaker based on the speaker embedding and the prosodic features.

10. The method of claim 9, further comprising:
receiving new input text; and
generating synthesized speech in the personalized voice based on the new input text.

11. The method of claim 10, wherein the new target reference speech comprises spoken language utterances in a first language and the new input text comprises text-based language utterances in a second language, the method further comprising:
identifying a new target language based on the second language associated with the new input text;
accessing a language embedding configured to control language information for the synthesized speech; and
generating the synthesized speech in the second language using the language embedding.

12. The method of claim 9, wherein the feature extractor is further configured to denoise the new target reference speech before extracting the acoustic features and the prosodic features.

13. A system configured for facilitating a creation of a zero-shot personal text-to-speech model, the system comprising:
at least one hardware processor; and
at least one hardware storage device storing:
(a) a first set of computer-executable instructions that are executable by one or more processors of a remote computing system for causing the remote computing system to at least:
access a feature extractor configured to extract acoustic features and prosodic features from new target reference speech associated with a new target speaker,
access a speaker encoder configured to generate a speaker embedding corresponding to the new target speaker based on the acoustic features extracted from the new target reference speech,
access a text-to-speech module configured to generate a personalized voice corresponding for the new target speaker based on the speaker embedding and the prosodic features extracted from the new target reference speech without applying the text-to-speech module on new labeled training data associated with the new target speaker, and
generate the personalized text-to-speech model by compiling the feature extractor, the speaker encoder, and the text-to-speech module in such a manner that the acoustic features extracted by the feature extractor are provided as input to the speaker encoder and such that (i) the prosodic features extracted by the feature extractor and (ii) the speaker embedding generated by the speaker encoder are provided as input to the text-to-speech module, thereby configuring the personalized text-to-speech model to generate the personalized voice for the new target speaker as model output in response to applying the machine learning model to model input comprising the new target reference speech; and
(b) a second set of computer-executable instructions that are executable by the at least one hardware processor for causing the system to send the first set of computer-executable instructions to the remote computing system.

14. The system of claim 13, wherein the first set of computer-executable instructions further include instructions for the remote computing system to execute the first set of computer-executable instructions for generating the zero-shot personal text-to-speech model.

15. The system of claim 14, wherein the first set of computer-executable instructions further include instructions for causing the remote system to, prior to generating the zero-shot personal text-to-speech model, apply the text-to-speech module to a multi-speaker multi-lingual training corpus to train the text-to-speech module using a speaker cycle consistency training loss.
